(19) United States
(12) Patent Application Publication
(10) Pub. No.: US 2008/0178734 A1
(43) Pub. Date: Jul. 31, 2008

(54) INERT GAS METHOD OF ENVIRONMENTAL CONTROL FOR MOISTURE SENSITIVE SOLIDS DURING STORAGE AND PROCESSING

(75) Inventors: Kevin P. BUTLER, Broadview Heights, OH (US); Jeffry E. FOX, Shaker Heights, OH (US); William SPANG, Jefferson, OH (US)

Correspondence Address: HAHN LOESER & PARKS, LLP, One GOJO Plaza, Suite 300, AKRON, OH, 44311-1076, US

(73) Assignee: LINCOLN GLOBAL, INC., City of Industry, CA (US)

(21) Appl. No.: 11/627,470

(22) Filed: Jan. 26, 2007

(51) Int. Cl. B01D 53/26; B65D 81/20

(52) U.S. Cl. 95/12; 206/6; 62/78; 73/31.03

(57) ABSTRACT

A method, apparatus, and system for controlling an environment within a container having at least one material type. An inert gas is introduced into the container to displace any harmful atmospheric components that may be present in the container, which could react with the solid material in the container. The displaced harmful atmospheric components are expelled from the container to a measuring device which identifies the concentration of the expelled components. The amount of inert gas being introduced into the container may be controlled in response to the measured results.

### TECHNICAL FIELD

Certain embodiments of the present invention relate to environmental control. More particularly, certain embodiments of the present invention relate to controlling an environment within a container containing a material type (e.g., flux powder used in arc welding applications).

### BACKGROUND OF THE INVENTION

The correct method to store and process industrial chemicals prior to use is a universal concern across many process industries. More specifically, it is well known that certain chemicals have a tendency to be adversely affected by the presence of moisture, oxygen, or other reactive atmospheric components during storage and processing. Solutions to this problem can be both costly and complex, thus making such solutions unattractive to the industry as a whole. The welding industry is an example of an industry that uses solid materials that should be protected from reacting with harmful components in order to avoid undesirable welding results.

Further limitations and disadvantages of conventional, traditional, and proposed approaches will become apparent to one of skill in the art, through comparison of such systems and methods with embodiments of the present invention as set forth in the remainder of the present application with reference to the drawings.

### BRIEF SUMMARY OF THE INVENTION

A first embodiment of the present invention comprises a method of controlling an environment within a container capable of containing at least one material type. The method includes introducing an amount of an inert gas into the container containing the at least one material type. The method further includes measuring an amount of harmful atmospheric components expelled from the container as the inert gas is introduced. The method also includes adjusting the amount of the inert gas being introduced into the first end of the container in response to the measured amount of the harmful atmospheric components.

Another embodiment of the present invention comprises a system for controlling an environment within a container capable of containing at least one material type. The system includes a container capable of containing at least one material type. The system also includes an inert gas supply operationally connected to the container and capable of introducing an inert gas into the container capable of containing the at least one material type. The system further includes a measuring device operationally connected to the container and capable of measuring an amount of harmful atmospheric components expelled from the container as the inert gas is introduced.

A further embodiment of the present invention comprises a method of controlling an environment within a container capable of containing at least one material type. The method includes introducing an inert gas at a first flow rate into the container containing the at least one material type such that the inert gas expels harmful atmospheric components from the container. The method further includes continuously or periodically measuring an amount of the harmful atmospheric components expelled from the container.

Another embodiment of the present invention comprises an apparatus for controlling an environment within a container capable of containing at least one material type. The apparatus includes means for introducing an amount of an inert gas into the container containing the at least one material type. The apparatus further includes means for measuring an amount of harmful atmospheric components expelled from the container as the inert gas is introduced.

These and other advantages and novel features of the present invention, as well as details of illustrated embodiments thereof, will be more fully understood from the following description and drawings.

### BRIEF DESCRIPTION OF SEVERAL VIEWS OF THE DRAWINGS

FIG. 1 is a functional block diagram illustrating an exemplary embodiment of a system for controlling an environment within a container capable of containing at least one material type, in accordance with various aspects of the present invention;

FIG. 2 is a flowchart of a first exemplary embodiment of a method of controlling an environment within a container capable of containing at least one material type using the system of FIG. 1, in accordance with various aspects of the present invention; and

FIG. 3 is a flowchart of a second exemplary embodiment of a method of controlling an environment within a container capable of containing at least one material type using the system of FIG. 1, in accordance with various aspects of the present invention.

### DETAILED DESCRIPTION OF THE INVENTION

Certain embodiments of the present invention provide a system and methods of reducing or eliminating harmful atmospheric components both during short- and long-term storage and during processing for a wide range of material types (e.g., solid material). The harmful atmospheric components, when in the presence of the material, can react with the material, causing the material to change in an undesirable manner, or causing the process in which the material is used to be compromised. Therefore, it is desirable to eliminate or at least reduce the amount of harmful atmospheric components to an acceptable level.

Through the introduction of an inert gas at, for example, the bottom of a storage container or delivery device, any harmful atmospheric components present in the container or device can be reduced or eliminated. Further, the amount of inert gas used to control the atmosphere can be minimized by measuring the amount of harmful components in the container's exhaust and controlling the inert gas flow accordingly. Most of the common reactive atmospheric agents can be accurately measured in the gas phase using Fourier-Transform Infrared Spectroscopy (FTIR). By coupling a Fourier Transform Infrared (FTIR) spectrometer to the vent of a controlled-atmosphere storage or delivery system, the amount of inert gas used to control the atmosphere can be controlled, based on the composition of the atmosphere itself.

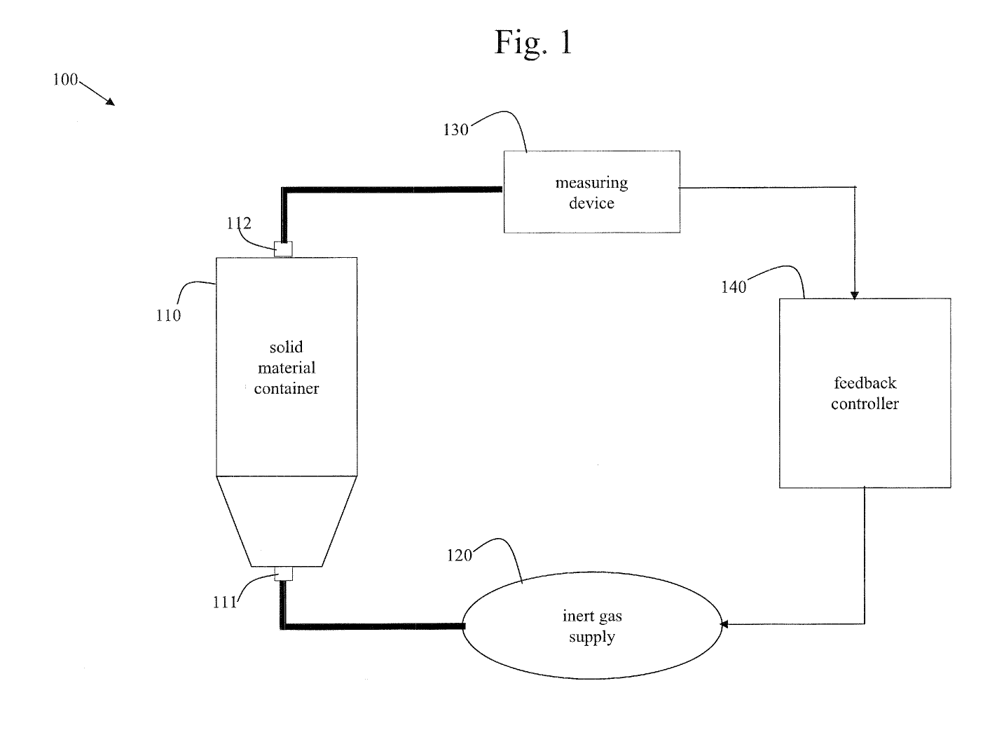

FIG. 1 is a functional block diagram illustrating an exemplary embodiment of a system 100 for controlling an environment within a container capable of containing at least one material type, in accordance with various aspects of the present invention. The system 100 comprises a container 110 containing at least one type of material (e.g., a flux powder capable of being used in flux-cored arc welding applications, or a material capable of being used to manufacture a flux powder used in arc welding). The container 110 may be a storage device capable of storing the material, or a delivery device capable of delivering the material to another device during processing (e.g., when filling an arc welding consumable with flux powder). The container 110 includes an inlet port 111 (e.g., at a first bottom end of the container 110) and an exit or exhaust port 112 (e.g., at a second top end of the container). In accordance with an embodiment of the present invention, the container 110 is substantially closed to inhibit external harmful atmospheric components from entering the container 110.

The system 100 also comprises an inert gas supply 120 operationally connected to the container 110 at the inlet port 111. The inert gas supply 120 is capable of introducing an inert gas (e.g., argon) into the inlet port 111 of the container 110. The inert gas supply 120 may be a typical gas tank with an automatic release valve that can be controlled electronically, in accordance with an embodiment of the present invention. Other inert gases such as, for example, helium, neon, krypton, xenon, radon, or molecular nitrogen may be used as the inert gas supply 120, in accordance with various embodiments of the present invention. As an option, the inert gas supply 120 can include a heater to warm the inert gas to a desirable temperature.

The system 100 further comprises a measuring device 130 (e.g., a Fourier Transform Infrared (FTIR) spectrometer) operationally connected to the container 110 at the exhaust port 112. The measuring device 130 is capable of measuring an amount (e.g., a concentration in parts per million, ppm) of harmful (e.g., reactive) atmospheric components (e.g., molecules of moisture, molecules of water, oxygen, carbon dioxide, and/or hydrogen) expelled from the exhaust port 112 of the container 110 as the inert gas is introduced.

An FTIR spectrometer typically comprises an infrared source, a beam splitter, a fixed mirror, a moveable mirror that translates back and forth, a detector, and input and output focusing lenses. The beam splitter is made of a material that transmits half of the incident radiation hitting the beam splitter, and reflects back the other half of the radiation. Therefore, radiation from the source hits the beam splitter and divides into two beams. A first beam is transmitted through the beam splitter to the fixed mirror and the second beam is reflected off of the beam splitter and travels to the moving mirror. Both mirrors reflect the radiation from the beams back to the beam splitter. Again, half of the reflected radiation is transmitted and half is reflected by the beam splitter. This results in one beam going to the detector and another beam going back to the source. An FTIR spectrometer collects all wavelengths at the same time.

FTIR spectroscopy is a useful tool for identifying types of chemical bonds of molecules by generating infrared absorption spectra. The wavelengths of the light absorbed are characteristic of the type of chemical bond of the material being analyzed. In general, the strength of the absorption is proportional to the concentration of the chemical bond present in a sample being analyzed. FTIR spectroscopy can be applied to gases, liquids and solids in various applications. In FTIR spectroscopy, information is converted from an interference pattern (an interferogram) to a spectrum using a Fourier transform technique. Today, it is possible to construct or purchase simple, yet rugged and inexpensive, FTIR spectrometers for use in applications such as described herein.

The system 100 also comprises a feedback controller 140 operationally connected between the measuring device 130 and the inert gas supply 120. The feedback controller 140 is capable of adjusting the amount of the inert gas being introduced into the inlet port 111 of the container 110 by the inert gas supply 120 in response to the measured amount of the harmful atmospheric components. In accordance with an embodiment of the present invention, the feedback controller 140 comprises a functional model implemented in software on a processor-based platform (e.g., a programmable controller, a distributed control system, a PC, or a workstation). In accordance with another embodiment of the present invention, the feedback controller 140 comprises a functional model implemented in firmware in one or more application specific integrated circuits (ASICs), for example. The feedback controller 140 may possibly be implemented in other ways as well, in accordance with alternative embodiments of the present invention. For example, the feedback controller 140 may comprise an addressable memory device acting as a simple look-up-table (LUT). The output of the measuring device 130 is the input to the LUT which is translated into an output by the LUT and serves as a control input to the inert gas supply 120. In accordance with an embodiment of the present invention, the measuring device 130 and the feedback controller 140 can be integrated into a single device. In accordance with a further embodiment of the present invention, the inert gas supply 120, the measuring device 130, the feedback controller 140, and other ancillary equipment may be integrated into a single apparatus or system.

During operation, the system 100 introduces an inert gas into the inlet port 111 of the container 110 containing the material. As the inert gas fills the container 110, any harmful atmospheric components present within the container begin to be displaced and expelled from the container 110 through the exhaust port 112. The material is not displaced from the container 110 due to the introduction of the inert gas. The measuring device 130 continuously or periodically monitors the presence and amount of any expelled atmospheric components and reports the results to the feedback controller 140.

If the amount of measured harmful atmospheric components increases over time, the feedback controller 140 can command the inert gas supply 120 to increase the amount of inert gas being supplied to the container 110 (e.g., by increasing the flow rate of the inert gas to the container 110). If the amount of measured harmful atmospheric components decreases over time, the feedback controller 140 can command the inert gas supply 120 to decrease the amount of inert gas being supplied to the container 110 (e.g., by decreasing the flow rate of the inert gas to the container 110). As a result, the level or amount of harmful atmospheric components within the container 110 can be regulated to an acceptable level, thus using only an amount of inert gas for reaching and maintaining the level of acceptability, and no more.

In accordance with an alternative embodiment of the present invention, the feedback controller is not used. Instead, an operator reacts to the measurements and manually adjusts the inert gas in response to the measurements. In accordance with another alterative embodiment of the present invention, the input port and the exhaust port may comprise one and the same port such that the harmful atmospheric components are expelled from and measure at the same port into which the inert gas in introduced. However, in such an alternative embodiment, the system may use, in addition, a means for extracting gas from the space of interest.

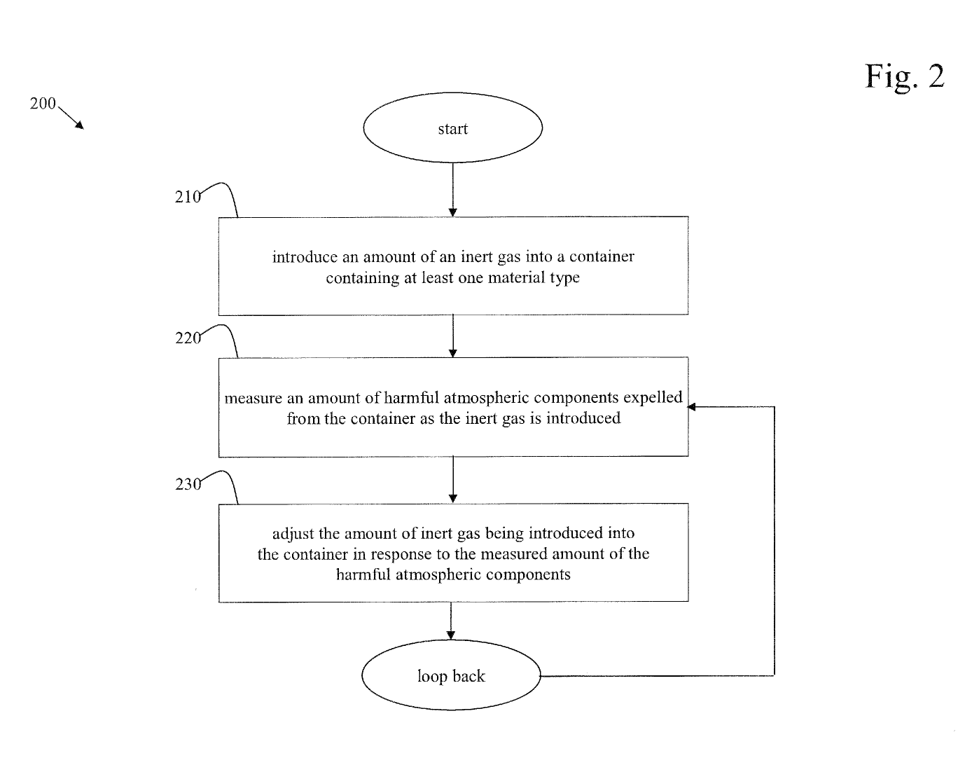

FIG. 2 is a flowchart of a first exemplary embodiment of a method 200 of controlling an environment within a container 110 capable of containing at least one material type using the system 100 of FIG. 1, in accordance with various aspects of the present invention. In step 210, an amount of an inert gas is introduced into a container containing at least one material type. In step 220, an amount of harmful atmospheric components expelled from the container is measured as the inert gas is introduced.

The method may further include an additional step 230, for adjusting the amount of inert gas being introduced into the container in response to the measured amount of the harmful atmospheric components. In such a scenario, the method 200 can loop back to step 220 to again measure an amount of harmful atmospheric components, as the amount of undesirable components may have changed over time, for example, due to leaks in the container. The process can continue, back and forth between steps 220 and 230 to regulate the expelled components to a desired level.

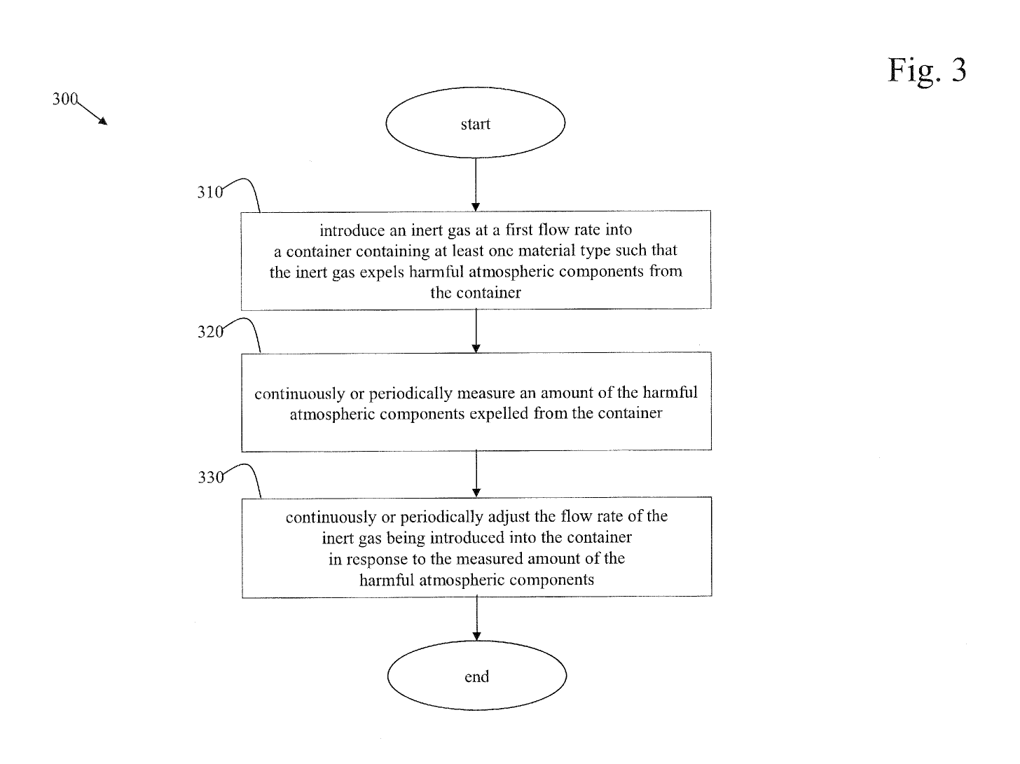

FIG. 3 is a flowchart of a second exemplary embodiment of a method 300 of controlling an environment within a container 110 capable of containing at least one material type using the system 100 of FIG. 1, in accordance with various aspects of the present invention. In step 310, an inert gas is continuously introduced at a first flow rate into an inlet port of a container containing at least one material type such that the inert gas expels harmful atmospheric components from the container. In step 320, an amount of the harmful atmospheric components expelled from the container is continuously or periodically measured.

The method may further include a step 330, where the flow rate of the inert gas being introduced into the inlet port of the container is continuously or periodically adjusted in response to the measured amount of the harmful atmospheric components.

In accordance with an embodiment of the present invention, the material type is a solid material being a flux powder and the inert gas is argon. The amount of argon supplied to the container is controlled via the feedback controller in accordance with the amount of moisture (vaporized H₂O) detected in the exhaust gas. The container does not have to be “air tight” and the inert gas may be warmed to assist in the removal of moisture from the material in storage, as well as to control temperature. The inert gas may further reduce the moisture content of the solid material by reducing the partial pressure of oxygen and water vapor in the atmosphere, thus promoting the reversal of chemical reactions that may have occurred between atmospheric components (e.g., oxygen and moisture) and the solid material. The effect of the inert gas increases as its molecular weight increases. Any gas with a molecular weight greater than air (approximately 29 grams/mole) will sink to the bottom of the container and displace air pockets resulting from, for example, material transfer. Argon, for example, has a molecular weight of 40 grams per mole and will readily displace any air below it.

Embodiments of the present invention can be applied anywhere in storage or delivery systems, as long as the material is being stored in a substantially closed container. Examples of such containers include chemical storage containers, chemical weigh bins, flux weigh containers, flux blenders, and fill station hoppers and feed tubes.

Embodiments of the present invention are applicable to all material storage and delivery systems that would benefit from maintaining an inert atmosphere. For example, the welding industry manufactures flux-cored arc welding (FCAW) electrodes that are usually filled with solid powders, some of which are quite moisture-sensitive. If the moisture-sensitive materials are allowed to stay in a humid environment prior to insertion into the electrode, the materials will adsorb or absorb moisture. This has a very detrimental effect on the diffusible hydrogen performance of electrodes in general, and in particular to the class of electrodes known collectively as “low-hydrogen electrodes”. The extra moisture in the chemicals can transfer through the welding arc and into the weld metal, diffusing into the metal matrix. As the weld metal cools, the solubility of hydrogen decreases and the hydrogen comes out of solution and diffuses through the matrix. The result of the diffusion is the creation of small pockets of hydrogen that create stress concentrators that promote cracks, a phenomenon known as Hydrogen Induced Cracking (HIC). Eliminating the hydrogen from the system (i.e., from the electrode) in the first place is typically the best way to avoid HIC.

Flux-cored arc welding (FCAW) uses a continuously fed consumable tubular electrode containing flux and a constant voltage, a constant current, or other variety of welding power supply. The flux may be relied upon to generate protection from the negative effects that can be caused by the surrounding air during the welding process. Alternatively, an externally supplied shielding gas can be used to negate the effects of the air. During a typical manufacturing process, the flux cored electrode starts out as a flat metal strip that is shaped into a “U” configuration. The flux material (and possibly other alloying elements) is deposited into the “U”. The “U” configuration is then closed to form a tubular configuration using a series of forming rolls. During a FCAW welding operation, the flux cored electrode acts as a continuous electrode that is fed into the arc and is melted into the welding joint.

As an example, a Plant A stores moisture-sensitive materials in relatively closed containers at room temperature. During the winter months, the humidity in the air is low, and the measured diffusible hydrogen from FCAW electrodes is also low. When summer arrives, the plant notices occasional failures in diffusible hydrogen tests. Since the problem is intermittent, the problem is dismissed as isolated bad batches or sporadic issues with the chemical vendors. However, closer inspection would show that the moisture content of the fill powder had increased in the summer, and may have been a contributor to the increased diffusible hydrogen levels in the welds.

Continuing with the example, a Plant B understands the potential moisture issues associated with chemical storage for low hydrogen electrode manufacturing. The plant employs the inert gas storage system, as described herein, and controls the storage condition to a warm, low humidity environment all year long. The system operates under constant control, and in the low humidity winter months, needs only to provide a very small amount of warm purge gas. Conversely, in the more humid summer months, the system provides an increased flow of purge gas to make up for leaks in the storage container and the overall increase in ambient humidity (which may affect the chemicals before arrival at the plant). The gas does not need significant warming in the summer, as the ambient temperature is already somewhat high. The plant also uses inert gas systems to maintain passivated environments in the flux storage containers, flux blenders, and flux delivery system to the manufacturing line to the point where the flux is introduced into the electrode sheath. As a result of using these systems, Plant B maintains a consistent and low level of diffusible hydrogen in welds made with their FCAW electrodes all year long and do not have the sporadic failure problem seen in Plant A.

In summary, FCAW electrodes manufactured using the inert gas system and methods described herein will deliver much more consistent diffusible hydrogen performance. The system control ensures an economic operation without significant waste and the system may adapt for day-to-day atmospheric conditions with or without operator interaction. The use of an inert gas that is heavier than air assures that the entire container is purged of harmful atmospheric components. Depending on the type of protection required, the inert gas and/or its temperature can be changed to suit the process.

While certain previous examples given herein refer to a method, system, and apparatus to control the environment for materials and flux powders used in the manufacture of FCAW electrodes, the method, system, and apparatus may also be used for materials and flux powders used in other arc welding applications, as well as other materials and material blends where the potential harmful effects of the environment demand such control.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. An apparatus for controlling an environment within a container capable of containing at least one material type, said method comprising:
means for introducing an amount of an inert gas into said container containing said at least one material type; and
means for measuring an amount of harmful atmospheric components expelled from said container as said inert gas is introduced.

2. The apparatus of claim 1 further comprising means for adjusting said amount of said inert gas being introduced into said container in response to said measured amount of said harmful atmospheric components.

3. The apparatus of claim 1 wherein said material type comprises a solid material capable of being used to manufacture a flux powder used in arc welding.

4. The apparatus of claim 1 wherein said material type comprises a flux powder capable of being used to manufacture flux-cored arc welding electrodes.

5. The apparatus of claim 1 wherein said harmful atmospheric components include molecules of moisture.

6. The apparatus of claim 1 wherein said harmful atmospheric components include molecules of at least one of water, oxygen, carbon dioxide, and hydrogen.

7. The apparatus of claim 1 wherein said container comprises a storage device capable of storing said material type.

8. The apparatus of claim 1 wherein said container comprises a delivery device capable of delivering said material type to another device.

9. The apparatus of claim 1 wherein said container is substantially closed to inhibit external harmful atmospheric components from entering said container.

10. The apparatus of claim 1 wherein said inert gas comprises at least one of argon, helium, neon, krypton, xenon, radon, and molecular nitrogen.

11. A system for controlling an environment within a container capable of containing at least one material type, said system comprising:
a container capable of containing at least one material type;
an inert gas supply operationally connected to said container and capable of introducing an inert gas into said container capable of containing said at least one material type; and
a measuring device operationally connected to said container and capable of measuring an amount of harmful atmospheric components expelled from said container as said inert gas is introduced.

12. The system of claim 11 further comprising a feedback controller operationally connected between said measuring device and said inert gas supply and capable of adjusting said amount of said inert gas being introduced into said container by said inert gas supply in response to said measured amount of said harmful atmospheric components.

13. The system of claim 11 wherein said material type comprises a solid material capable of being used to manufacture a flux powder used in arc welding.

14. The system of claim 11 wherein said material type comprises a flux powder capable of being used to manufacture flux-cored arc welding electrodes.

15. The system of claim 11 wherein said container comprises a storage device capable of storing said material type.

16. The system of claim 11 wherein said container comprises a delivery device capable of delivering said material type to another device.

17. The system of claim 11 wherein said measuring device comprises a Fourier transform infrared spectrometer.

18. The system of claim 12 wherein said feedback controller comprises a processor-based platform.

19. A method of controlling an environment within a container capable of containing at least one material type, said method comprising:
introducing an inert gas at a first flow rate into said container containing said at least one material type such that said inert gas expels harmful atmospheric components from said container; and
continuously or periodically measuring an amount of said harmful atmospheric components expelled from said container.

20. The method of claim 19 further comprising continuously or periodically adjusting said flow rate of said inert gas being introduced into said container in response to said measured amount of said harmful atmospheric components.

21. The method of claim 19 wherein said material type comprises a solid material capable of being used to manufacture a flux powder used in arc welding.

22. The method of claim 19 wherein said material type comprises a flux powder capable of being used to manufacture flux-cored arc welding electrodes.

23. The method of claim 19 wherein said harmful atmospheric components include molecules of moisture.

24. The method of claim 19 wherein said harmful atmospheric components include molecules of at least one of water, oxygen, carbon dioxide, and hydrogen.

25. The method of claim 19 wherein said container is substantially closed to inhibit external harmful atmospheric components from entering said container.

26. The method of claim 19 wherein said inert gas comprises at least one of argon, helium, neon, krypton, xenon, radon, and molecular nitrogen.
